(19) United States
(12) Patent Application Publication
(10) Pub. No.: US 2020/0381976 A1
(43) Pub. Date: Dec. 3, 2020

(54) MOTOR AND ELECTRICAL DEVICE INCLUDING SAME

(71) Applicant: Nidec Corporation, Kyoto (JP)

(72) Inventors: Yusaku YOSHIDA, Dalian (CN); Tatsuya ONISHI, Dalian (CN); Xiao ZHANG, Dalian (CN)

(21) Appl. No.: 16/829,106

(22) Filed: Mar. 25, 2020

(30) Foreign Application Priority Data
May 31, 2019 (CN) 201910467338.0

(51) Int. Cl. H02K 5/22

(52) U.S. Cl. CPC H02K 5/225

(57) ABSTRACT

A motor includes a rotor, a stator opposite to the rotor in a radial direction, and a housing accommodating the stator and the rotor. The housing includes a body portion and an accommodating portion disposed on a radially outer side of the body portion, having an opening located on a side of the rotor and the stator in an axial direction, and providing, with the body portion, a through-hole capable of accommodating a conducting wire. An inner wall of the accommodating portion includes a first guiding wall. A first end portion on a side of the first guiding wall in the axial direction is located closer to a radially inner side than a second end portion on another side of the first guiding wall in the axial direction. The first guiding wall includes an inclined surface inclined from the second end portion toward the first end portion.

### CROSS REFERENCE TO RELATED APPLICATION

The present application claims priority under 35 U.S.C. § 119 to Chinese Application No. 201910467338.0 filed on May 31, 2019, the entire contents of which are hereby incorporated herein by reference.

### 1. FIELD

The present disclosure relates to a motor and an electrical device.

### 2. BACKGROUND

With the development of technologies, motors are broadly applied in various fields. Meanwhile, more and more electronic components are disposed in a motor. In the related art, it normally requires that an electronic component or a power supply located on a side of a motor in an axial direction be electrically connected to an electronic component located on the other side of the motor in the axial direction or to the motor itself via a conducting wire.

It should be noted that the above description is merely provided for the convenience of clearly and comprehensively describing the technical solutions of the disclosure and facilitating the understanding of those skilled in the art. These technical solutions discussed above shall not be deemed well-known by those skilled in the art simply for having been described above.

Conventionally, when an electronic component or a power supply located on a side of a motor in an axial direction is electrically connected to an electronic component located on the other side of the motor in the axial direction or to the motor itself, an accommodating portion that is integrally formed with a housing of the motor and runs through in the axial direction is usually provided on a radially outer side of the motor. A conducting wire is accommodated in the accommodating portion, and two ends of the conductive wire are respectively connected to the electronic component or the power supply located on the side in the axial direction and the electronic component located on the other side in the axial direction or the motor itself.

### SUMMARY

However, the inventor discovered that in a case where such a structure is adopted, when the conducting wire is to be connected to the electronic component, the conducting wire needs to be further manually pulled from the radially outer side of the motor to a radially inner side of the motor for connection. Therefore, the manufacturing processes of the motor increase. Besides, pulling improperly may easily damage the conducting wire, which increases the scrap rate.

According to an example embodiment of present disclosure, a motor includes a rotor rotatable about a central axis, a stator opposite to the rotor in a radial direction, and a housing accommodating the stator and the rotor. The housing includes a body portion and an accommodating portion. The accommodating portion is disposed on a radially outer side of the body portion, the accommodating portion and the body portion provide a through-hole capable of accommodating a conducting wire, and the accommodating portion is provided with an opening located on a side of the rotor and the stator in an axial direction. An inner wall of the accommodating portion includes a first guiding wall. A first end portion on a side of the first guiding wall in the axial direction is located on a position closer to a radially inner side than a second end portion on another axial side of the first guiding wall in the axial direction. The first guiding wall is provided with an inclined surface inclined from the second end portion toward the first end portion.

According to another example embodiment of the present disclosure, an electrical device includes the motor according to the example embodiment of the present disclosure described above.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view of a structure of a motor according to an example embodiment of the present disclosure.

FIG. 2 is a cross-sectional view of a structure of a housing according to an example embodiment of the present disclosure.

FIG. 3 is a top view of the structure of a motor according to an example embodiment of the present disclosure.

FIG. 4 is a top view of the structure of a housing according to an example embodiment of the present disclosure.

FIG. 5 is a bottom view of the structure of a motor according to an example embodiment of the present disclosure.

### DETAILED DESCRIPTION

The foregoing and other features of the disclosure will become apparent from the following specification with reference to the accompanying drawings. Specific example embodiments of the present disclosure are disclosed in the following specification and the accompanying drawings. The specification and the accompanying drawings describe several example embodiments to which the principles of the disclosure are applicable. However, it should be understood that, the present disclosure is not limited to the example embodiments described herein, but shall include all modifications, variations and equivalents falling within the scope of the appended claims.

In the example embodiments of the present disclosure, singular forms such as “a/an” and “the” include plural forms and should be understood in a broad sense as a meaning of “a type” or “a kind” instead of “one”. In addition, the term “the” should be understood as including both a singular form and a plural form, unless otherwise clearly stated in the context. In addition, the term “according to” should be understood as “at least partially according to . . . ”, and the term “based on” should be understood as “at least partially based on . . . ”, unless otherwise clearly stated in the context.

In the example embodiments of the disclosure, a direction parallel or substantially parallel to a direction extending along a central axis of a motor is referred to as an “axial direction” or an “extending direction of an axial direction”, a side away from the central axis in the radial direction is referred to as a “radial outer side”, a side close to the central axis in the radial direction is referred to as a “radial inner side”, a radial direction with the central axis as a center is referred to as a “radial direction”, and a direction around/about the central axis is referred to as a “circumferential direction”. It should be noted that the definitions made on various directions in this specification are merely for convenience of description of the example embodiments of the disclosure, and are not intended to limit the directions of the motor in use and during manufacturing.

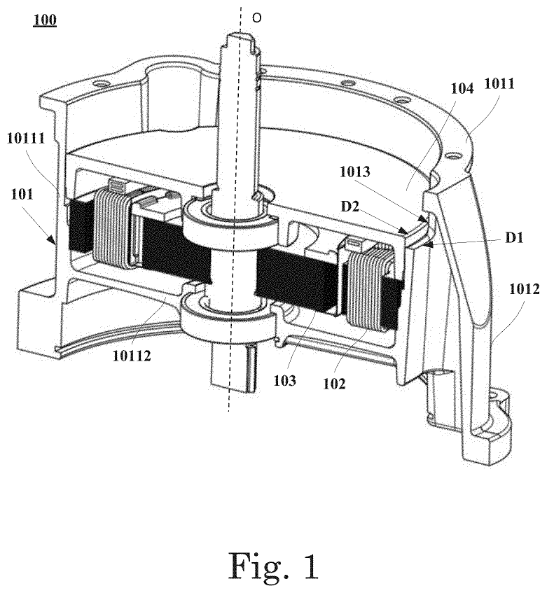

Example Embodiment of the disclosure provides a motor. FIG. 1 is a cross-sectional view of a structure of a motor 100 according to example Embodiment of the disclosure. In one or some example embodiments, as shown in FIG. 1, the motor 100 includes a rotor 103 rotating about a central axis O′, a stator 102 opposite to the rotor 103 in a radial direction, and a housing 101 accommodating the stator 102 and the rotor 103.

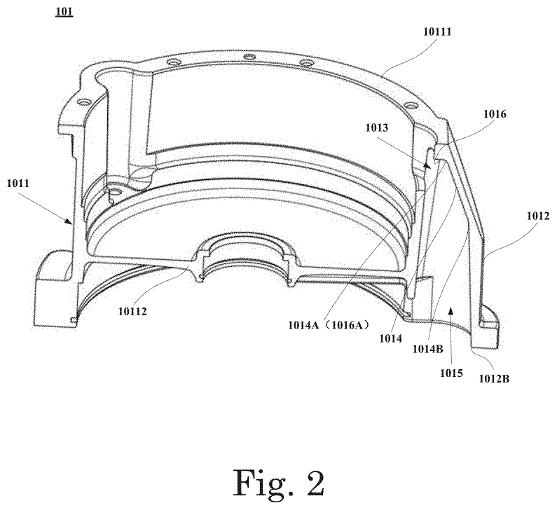

FIG. 2 is a cross-sectional view of a structure of the housing 101 according to example Embodiment of the present disclosure. In one or more example embodiments, as shown in FIG. 2, the housing 101 preferably includes a body portion 1011 and an accommodating portion 1012. The accommodating portion 1012 is disposed on a radially outer side of the body portion 1011, and the accommodating portion 1012 and the body portion 1011 provide a through-hole 1015 capable of accommodating a conducting wire.

The accommodating portion 1012 is provided with an opening 1013 located on a side of the rotor 103 and the stator 102 in an axial direction. An inner wall of the accommodating portion 1012 includes a first guiding wall 1014, where a first end portion 1014A on the side of the first guiding wall 1014 in the axial direction is located on a position closer to a radially inner side than a second end portion 1014B on the other side of the first guiding wall 1014 in the axial direction, and the first guiding wall 1014 is provided with an inclined surface inclined from the second end portion 1014B toward the first end portion 1014A.

By arranging the motor so that the accommodating portion 1012 is disposed in the housing 101 of the motor 100, and the first end portion 1014A on the side of at least a portion of the inner wall of the accommodating portion 1012 in the axial direction is located on the position closer to the radially inner side than the second end portion 1014B on the other side in the axial direction, the at least a portion of the inner wall is provided with the inclined surface inclined from the second end portion 1014B to the first end portion 1014A. In this way, when the conducting wire is inserted into the opening 1013 through the through-hole 1015, the accommodating portion 1012 is capable of guiding the conducting wire to the radially inner side of the housing 101 through the inclined surface, thereby simplifying the manufacturing processes of the motor and facilitating the production efficiency of the motor.

In one or more example embodiments of the present disclosure, as shown in FIG. 1 and FIG. 2, the side in the axial direction may correspond to the upper direction shown in FIG. 1 and FIG. 2, and the other side in the axial direction may correspond to the lower direction shown in FIG. 1 and FIG. 2.

In one or more example embodiments of the present disclosure, the body portion 1011 and the accommodating portion 1012 may be integrally formed. For example, the housing 101 may be formed through integral plastic injection using a mold. In this way, the strength of the housing 101 is ensured. However, the present disclosure is not limited thereto. For example, the body portion 1011 and the accommodating portion 1012 may also be separately formed, and the housing 101 is formed by mounting the accommodating portion 1012 on an outer surface of the body portion 1011.

In one or more example embodiments of the present disclosure, when an electronic component located on the side of the motor 100 in the axial direction is to be connected with an electronic component located on the other side in the axial direction, the conducting wire may be inserted from an opening on the other side of the accommodating portion 1012 in the axial direction and then be exposed to the outside from the opening 1013 through guidance of the first guiding wall 1014. However, the present disclosure is not limited thereto. For example, the conducting wire may also be inserted from the opening 1013, and be exposed to the outside from the opening on the other side of the accommodating portion 1012 in the axial direction.

In one or more example embodiments of the present disclosure, the opening 1013 is located on the side of the housing 101 in the axial direction, and the first end portion 1014A on the side of the first guiding wall 1014 in the axial direction is closer to the radially inner side than the second end portion 1014B on the other side in the axial direction. However, the present disclosure is not limited thereto. For example, a second opening (not shown) may also be provided on the other side of the accommodating portion 1012 in the axial direction, so that an end portion of at least a portion of the inner wall of the accommodating portion 1012 that is close to the second opening is closer to the radially inner side than an end portion away from the second opening. In this way, the conducting wire may also be guided to the radially inner side through a corresponding structure on the other side of the motor in the axial direction.

In one or more example embodiments of the present disclosure, the through-hole 1015 may be provided by a joint enclosure of the accommodating portion 1012 and a portion of the body portion 1011 opposite to the accommodating portion 1012 in the radial direction. In this way, the body portion 1011 may be disposed as a continuous structure, which ensures the strength of the housing 101 and prevents dust and the like from entering the inside of the main body of the motor through the accommodating portion 1012. However, the present disclosure is not limited thereto. For example, it may also be that the body portion 1011 is not provided at the portion opposite to the accommodating portion 1012 in the radial direction. For example, a notch may be provided at the portion of the body portion 1011 that is opposite to the accommodating portion 1012 in the radial direction. In this way, the weight of the housing 101 is reduced.

In one or more example embodiments of the present disclosure, as shown in FIG. 2, the first guiding wall 1014 is provided with the inclined surface inclined from the second end portion 1014B to the first end portion 1014A. The inclined surface may be an inclined surface in any shape. For example, the inclined surface may be a flat surface, a curved surface, a surface bent at a certain angle, or the like.

In one or more example embodiments of the present disclosure, the second end portion 1014B on the other side of the first guiding wall 1014 in the axial direction may be located at any position of the inner wall of the accommodating portion 1012. For example, as shown in FIG. 2, in the axial direction, the second end portion 1014B is located at a middle position of the inner wall of the accommodating portion 1012; or the second end portion 1014B may also be located on an end portion 1012B on the other side of the accommodating portion 1012 in the axial direction.

In one or more example embodiments of the present disclosure, a portion of an outer wall of the accommodating portion 1012 that is opposite to the first guiding wall 1014 in the radial direction may be in any shape. For example, as shown in FIG. 2, a first end portion located on the side of the portion of the outer wall in the axial direction may be located on a position closer to the radially inner side than a second end portion on the other side of the portion of the outer wall in the axial direction, and the portion of the outer wall may be provided with an inclined surface inclined from the second end portion to the first end portion, thereby helping reduce the weight of the housing 101 and miniaturize the motor 100. However, the present disclosure is not limited thereto. The portion of the outer wall may also be in other shapes.

In one or more example embodiments of the present disclosure, as shown in FIG. 2, an opening direction of the opening 1013 is at least partially toward the radially inner side. In this way, when the conducting wire passes through the accommodating portion 1012 and is exposed to the outside from the opening 1013, an exposing direction of the conducting wire is at least partially toward the radially inner side. In an example embodiment, the opening direction of the opening 1013 may be completely toward the radially inner side. In another example embodiment, the opening direction of the opening 1013 may have a component toward the radially inner side and components toward directions other than the radially inner side.

In one or more example embodiments of the present disclosure, as shown in FIG. 2, the inner wall of the accommodating portion 1012 further includes a second guiding wall 1016. The second guiding wall 1016 extends along the radial direction. An end portion 1016A on a radially outer side of the second guiding wall 1016 is connected to the first end portion 1014A of the first guiding wall 1014. In this way, the exposing direction of the conducting wire is further guided by the second guiding wall 1016 to the radially inner side.

In one or more example embodiments of the present disclosure, as a shown in FIG. 1, the motor 100 may further be provided with a retainer 104. The retainer 104 is located on the radially inner side of the body portion 1011, and at least a portion of the opening 1013 is located on the side of the retainer 104 in the axial direction.

In one or more example embodiments of the present disclosure, the retainer 104 may be a bearing holder, but the present disclosure is not limited thereto. The retainer 104 may also be other components of the motor.

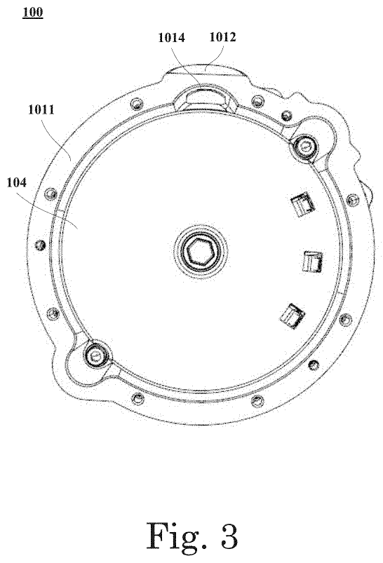

FIG. 3 is a top view of the structure of the motor according to example Embodiment of the present disclosure. In one or more example embodiments of the present disclosure, a projection of the first guiding wall 1014 on the axial direction does not overlap a projection of the retainer 104 on the axial direction. In this way, during assembly of the motor 100, the first guiding wall 1014 and the retainer 104 do not interfere with each other. Accordingly, the manufacturing processes of the motor 100 are further simplified.

In an example embodiment, in a case that the inner wall of the accommodating portion 1012 further includes the second guiding wall 1016, it may also be that a projection of the second guiding wall 1016 on the axial direction does not overlap the projection of the retainer 104 on the axial direction.

In one or more example embodiments, as shown in FIG. 1, the body portion 1011 includes a wall portion 10111. The wall portion 10111 is on a radially outer side of the rotor 103 and the stator 102 and surrounds the rotor 103 and the stator 102 in a circumferential direction. A circumferential outer wall of the retainer 104 that is at least located on a circumferential position same as the opening 1013 abuts against an inner wall of the wall portion 10111 of the body portion 1011. In this way, a sealing structure is provided between the retainer 104 and the housing 101.

For example, the circumferential outer wall of the retainer 104 that is located on the circumferential position same as the opening 1013 may abut against the inner wall of the wall portion 10111 of the body portion 1011. Alternatively, the circumferential outer wall of the retainer 104 that is located on the circumferential position same as the opening 1013 and the outer wall of other portions of the retainer 104 may all abut against the inner wall of the wall portion 10111. For example, the circumferential outer wall of the retainer 104 abuts against the inner wall of the wall portion 10111 on all positions in the circumferential direction. In this way, a sealing structure is provided in all the positions in the circumferential direction of the retainer 104 and the housing 101.

In one or more example embodiments of the present disclosure, the retainer 104 is capable of being mounted to the housing 101 by being pressed, screwed, or a combination thereof, into the housing 101.

For example, an outer diameter of the retainer 104 is approximately equal to an inner diameter of the housing 101, and the retainer 104 may be pressed into the housing 101. In this way, the motor 100 is able to be conveniently assembled, and the sealing structure between the retainer 104 and the housing 101 is simplified.

As another example, a first screw thread may be provided on the circumferential outer wall of the retainer 104, a second screw thread matching the first screw thread may be provided on the inner wall of the housing 101, and the retainer 104 may be screwed into the housing 101. In this way, the motor 100 is able to be conveniently assembled, and the strength of the motor 100 is enhanced.

In one or more example embodiments of present disclosure, a first edge portion D1 that is located on a same circumferential position as the opening 1013 and on the side of the wall portion 10111 in the axial direction is located on a position closer to the other side in the axial direction than a second edge portion D2 on the side of the retainer 104 in the axial direction. In this way, a degree to which the retainer 104 is pressed in is confirmed based on the exposure of the second edge portion D2 of the retainer 104 from the first edge portion D1 of the wall portion 10111, and it is ensured that the opening 1013 has sufficient space to expose the conducting wire to the outside. However, the disclosure is not limited thereto. The first edge portion D1 may also be located on a position closer to the side in the axial direction than the second edge portion D2 or be flush with the second edge portion D2.

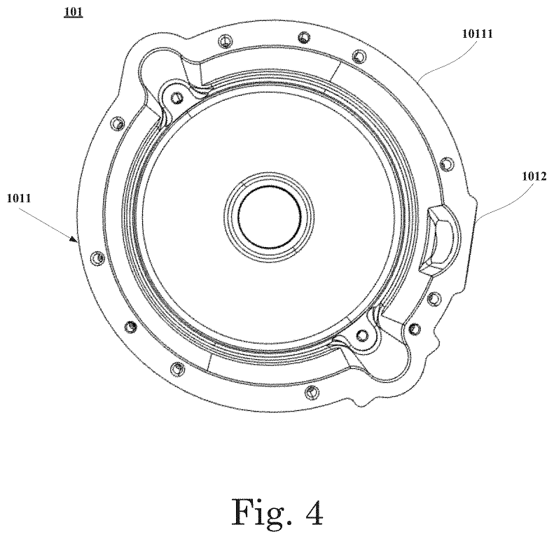

FIG. 4 is a top view of the structure of the housing according to example Embodiment of the present disclosure. As shown in FIG. 4, at least a portion of an outer wall of the accommodating portion 1012 protrudes from the wall portion 10111 of the body portion 1011 toward the radially outer side. In this way, the conducting wire may be effectively accommodated and guided without occupying the internal space of the motor 100 or expanding the overall size of the motor 100. However, the disclosure is not limited thereto. It may also be that the accommodating portion 1012 does not protrude from the wall portion 10111 of the body portion 1011 toward the radially outer side.

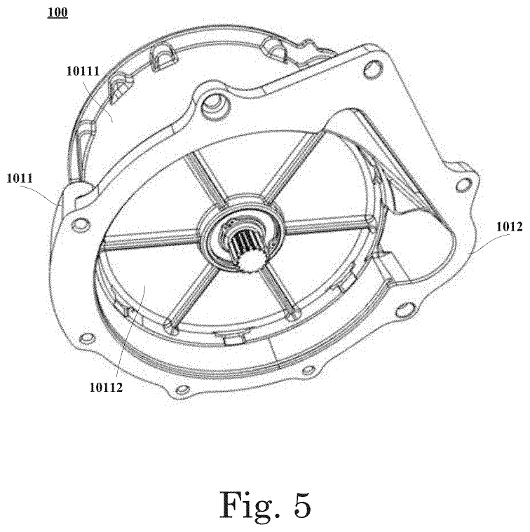

FIG. 5 is a bottom view of the structure of the motor according to example Embodiment of the present disclosure. As shown in FIG. 1 and FIG. 5, the body portion 1011 includes the wall portion 10111 and a bottom portion 10112. The wall portion 10111 is on the radially outer side of the rotor 103 and the stator 102, and surrounds the rotor 103 and the stator 102 in the circumferential direction, and the bottom portion 10112 is located on the other side of the rotor 103 and the stator 102 in the axial direction. The wall portion 10111 and the inner wall of the accommodating portion 1012 extend in the axial direction toward the other side of the housing 101 in the axial direction relative to the bottom portion 10112.

In this way, an accommodating space enclosed by the wall portion 10111 of the body portion 1011 and the accommodating portion 1012 of the housing 101 is provided at the bottom of the motor 100. However, the present disclosure is not limited thereto. The wall portion 10111 and the inner wall of the accommodating portion 1012 may also be flush with the bottom portion 10112 in the axial direction. Alternatively, an end portion on the other side of the accommodating portion 1012 in the axial direction may be located on a position closer to the side in the axial direction relative to the bottom portion 10112.

In the motor in the present example embodiment of the disclosure, the accommodating portion 1012 is disposed in the housing 101 of the motor 100, and the first end portion 1014A on the side of the at least a portion of the inner wall of the accommodating portion 1012 in the axial direction is located on a position closer to the radially inner side than the second end portion 1014B on the other side in the axial direction, so that the at least a portion of the inner wall is provided with the inclined surface inclined from the second end portion 1014B to the first end portion 1014A. In this way, the accommodating portion 1012 is capable of guiding the conducting wire to the radially inner side of the housing 101 to simplify the manufacturing processes of the motor and facilitate the production efficiency of the motor.

The present example embodiment of the disclosure provides an electrical device. The electrical device includes the motor described in example Embodiment of the disclosure. Because the structure of the motor has already been described in example Embodiment of the disclosure, the content is incorporated herein, and descriptions thereof will not be repeated.

In the electrical device in the present example embodiment of the disclosure, the structure of the motor described in example Embodiment of the disclosure is adopted. By disposing the accommodating portion in the housing of the motor, and providing the first end portion on the side of the at least a portion of the inner wall of the accommodating portion in the axial direction on the position closer to the radially inner side than the second end portion on the other side in the axial direction, the at least a portion of the inner wall is provided with the inclined surface inclined from the second end portion to the first end portion. In this way, the accommodating portion is capable of guiding a conducting wire to the radially inner side of the housing to simply the manufacturing processes of the motor and facilitate the production efficiency of the motor.

In the present example embodiment of the disclosure, the electrical device may be any electrical device using a motor. For example, the electrical device may be vehicle-mounted equipment using a motor, such as a brake system. However, the present example embodiment of the disclosure is not limited thereto. The motor in example Embodiment may also be used as a motor of other electrical devices, such as a motor of a household appliance device such as a power seat, an indoor unit of an air conditioner, an outdoor unit of an air conditioner, a drinking water dispenser, a washing machine, a sweeper, a compressor, an air supply fan, or a mixer, or used as a motor in various information devices, industrial devices, and the like.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a rotor rotatable about a central axis;
a stator opposite to the rotor in a radial direction; and
a housing accommodating the stator and the rotor; wherein
the housing includes a body portion and an accommodating portion;
the accommodating portion is disposed on a radially outer side of the body portion;
the accommodating portion and the body portion provide a through-hole capable of accommodating a conducting wire;
the accommodating portion is provided with an opening located on a side of the rotor and the stator in an axial direction;
an inner wall of the accommodating portion includes a first guiding wall;
a first end portion on a side of the first guiding wall in the axial direction is closer to a radially inner side than a second end portion on another side of the first guiding wall in the axial direction; and
the first guiding wall includes an inclined surface inclined from the second end portion toward the first end portion.

2. The motor according to claim 1, wherein an opening direction of the opening is at least partially toward the radially inner side.

3. The motor according to claim 1, wherein the inner wall of the accommodating portion includes a second guiding wall extending in the radial direction, and an end portion on a radially outer side of the second guiding wall is connected to the first end portion of the first guiding wall.

4. The motor according to claim 1, wherein the motor includes a retainer located on a radially inner side of the body portion, and at least a portion of the opening is located on a side of the retainer in the axial direction.

5. The motor according to claim 4, wherein a projection of the first guiding wall on the axial direction does not overlap a projection of the retainer on the axial direction.

6. The motor according to claim 5, wherein
the inner wall of the accommodating portion includes a second guiding wall extending in the radial direction, and an end portion on a radially outer side of the second guiding wall is connected to the first end portion of the first guiding wall; and
a projection of the second guiding wall on the axial direction does not overlap the projection of the retainer on the axial direction.

7. The motor according to claim 4, wherein
the body portion includes a wall portion located on a radially outer side of the rotor and the stator and surrounding the rotor and the stator in a circumferential direction; and
a circumferential outer wall of the retainer that is at least located on a same circumferential position as the opening abuts against an inner wall of the wall portion of the body portion.

8. The motor according to claim 7, wherein the retainer is capable of being pressed into and/or screwed into the housing.

9. The motor according to claim 7, wherein a first edge portion of the body portion on a side of the wall portion in the axial direction that is located on a same circumferential position as the opening is closer to another side in the axial direction than a second edge portion on a side of the retainer in the axial direction.

10. The motor according to claim 1, wherein at least a portion of an outer wall of the accommodating portion protrudes from a wall portion of the body portion toward a radially outer side.

11. The motor according to claim 1, wherein
the body portion includes a wall portion and a bottom portion;
the wall portion is on a radially outer side of the rotor and the stator, and surrounds the rotor and the stator in a circumferential direction;
the bottom portion is located on another side of the rotor and the stator in the axial direction; and
the wall portion and the inner wall of the accommodating portion extend in the axial direction toward another side of the housing in the axial direction relative to the bottom portion.

12. An electrical device comprising the motor according to claim 1.
